(19) United States
(12) Patent Application Publication
(10) Pub. No.: US 2025/0079915 A1
(43) Pub. Date: Mar. 6, 2025

(54) ROTOR AND STATOR

(71) Applicant: TOYOTA BOSHOKU KABUSHIKI KAISHA, Aichi-ken (JP)

(72) Inventor: Masaaki TAKEMOTO, Toyokawa-shi (JP)

(73) Assignee: TOYOTA BOSHOKU KABUSHIKI KAISHA, Aichi-ken (JP)

(21) Appl. No.: 18/815,051

(22) Filed: Aug. 26, 2024

(30) Foreign Application Priority Data
Aug. 29, 2023 (JP) 2023-139162

(51) Int. Cl. H02K 1/276; H02K 1/14

(52) U.S. Cl. CPC H02K 1/276; H02K 1/146

(57) ABSTRACT

A rotor includes a rotor core formed by rotationally stacking multiple iron core pieces or multiple blocks. The rotor core includes multiple magnet housing holes. A magnet is accommodated in each of the magnet housing holes. A portion of the rotor core between each magnet housing hole and an outer circumferential surface of the rotor core located on a radially outer side of the magnet housing hole is defined as a designated region. Some of the designated regions include at least one first designated region including a different-shape portion different in shape or position from those in the other designated regions. In the multiple iron core pieces or in the multiple blocks, the first designated region and one of the designated regions that does not include the different-shape portion overlap in an axial direction of the rotor.

### CROSS-REFERENCE TO RELATED APPLICATIONS

This application is based upon and claims the benefit of priority from prior Japanese Patent Application No. 2023-139162, filed on Aug. 29, 2023, the entire contents of which are incorporated herein by reference.

### BACKGROUND

### 1. Field

The present disclosure relates to a rotor and a stator.

### 2. Description of Related Art

A typical stator core is in a motor of an outer-rotor type. The stator core is a laminated body formed by stacking multiple stator steel sheets. The stator core is disposed inside a tubular rotor. Each of the stator steel sheets has a ring-shaped core back and multiple teeth that protrude from the core back and extend outward in the radial direction of the core back. The stator steel sheets include first stator steel sheets, in which one recess is provided at the center of the tip of each tooth, and second stator steel sheets, in which two recesses are provided at the center of the tip of each tooth. Due to magnetic interactions with the rotor, torque fluctuations occur in the first stator steel sheets and the second stator steel sheets of the stator core. The shapes and positions of the recesses in the first stator steel sheets and the second stator steel sheets are determined such that the torque fluctuations in the first stator steel sheets and the second stator steel sheets cancel each other out. Accordingly, the torque fluctuations in the stator core is reduced.

Steel sheets (hereinafter, referred to as iron core pieces) that form a laminated body of a motor core of related art including the stator core described in the publication are formed by a press device. When multiple types of iron core pieces having different shapes and positions of recesses are formed as in the case of the stator core described above, it is necessary to prepare punches for pressing iron core pieces of the respective types. This complicates the manufacturing processes of the motor core.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotor is employed in a magnet-embedded motor of an inner rotor type. The rotor includes a rotor core formed by rotationally stacking multiple iron core pieces or by rotationally stacking multiple blocks each formed by stacking multiple iron core pieces. The rotor core includes multiple magnet housing holes provided at intervals in a circumferential direction of the rotor. A magnet is accommodated in each of the magnet housing holes. A part of the rotor core between each magnet housing hole and an outer circumferential surface of the rotor core located on a radially outer side of the magnet housing hole is defined as a designated region. The designated regions include at least one first designated region including a different-shape portion different in shape or position from those in the other designated regions. In the multiple iron core pieces or in the multiple blocks, the first designated region and one of the designated regions that does not include the different-shape portion overlap in an axial direction of the rotor.

In another general aspect, a stator is employed in a magnet-embedded motor of an inner rotor type. The stator includes a stator core formed by rotationally stacking multiple iron core pieces or by rotationally stacking multiple blocks each formed by stacking multiple iron core pieces. The stator core includes an annular yoke and multiple teeth protruding from the yoke in a radial direction of the yoke. Coils are wound around the teeth. At least one of the teeth includes a different-shape portion different in shape or position from those in the other teeth. In the multiple iron core pieces or in the multiple blocks, the tooth including the different-shape portion and one of the teeth that does not include the different-shape portion overlap in an axial direction of the stator.

Other features and aspects will be apparent from the following detailed description, the drawings, and the claims.

### BRIEF DESCRIPTION OF THE DRAWINGS

FIG. 1 is a cross-sectional view of a motor.

FIG. 2 is a cross-sectional view of the motor, mainly showing designated regions in FIG. 1.

FIG. 3 is a graph showing a relationship between torque fluctuations and time in rotors of the present embodiment, Comparative Example 1, and Comparative Example 2.

FIG. 4 is a plan view showing a rotor core according to a first modification.

FIG. 5 is a plan view showing a rotor core according to a second modification.

FIG. 6 is a cross-sectional view of a motor, mainly showing designated regions according to a third modification.

FIG. 7 is a cross-sectional view of a motor, mainly showing designated regions according to a fourth modification.

FIG. 8 is a cross-sectional view of a motor, mainly showing designated regions according to a fifth modification.

FIG. 9 is a cross-sectional view of a motor, mainly showing first cutouts and second cutouts in a stator according to a sixth modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

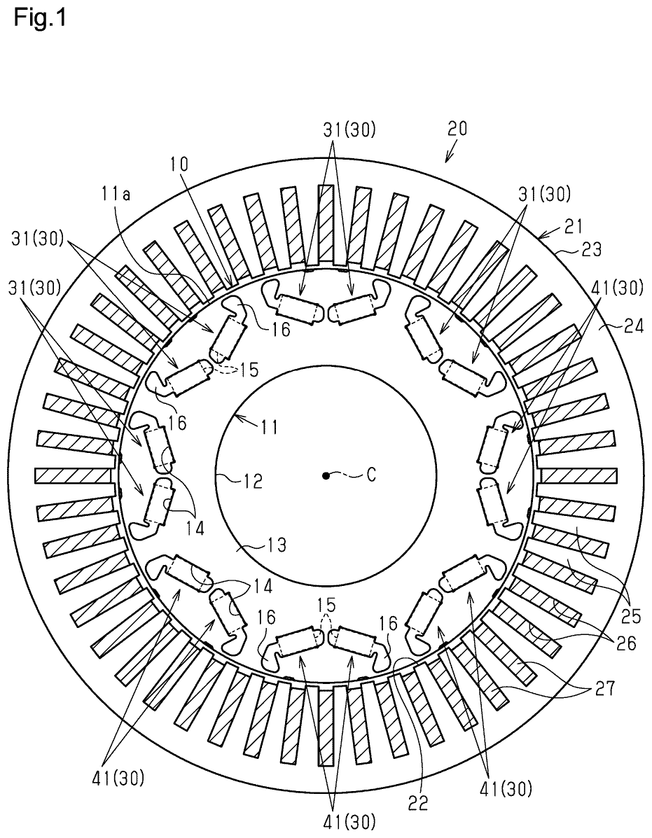

A rotor 10 according to one embodiment will now be described with reference to FIGS. 1 to 3.

As shown in FIG. 1, a motor includes the rotor 10 and a stator 20. The motor is a magnet-embedded motor of an inner rotor type

### Rotor 10

As shown in FIG. 1, the rotor 10 includes a tubular rotor core 11, which includes a center hole 12 and multiple magnet housing holes 14, magnets 15 accommodated in the magnet housing holes 14, and plastic 16 filling the magnet housing holes 14 to fix the magnets 15 to the rotor core 11. The rotor core 11 also includes multiple designated regions 30.

In the following description, an axial direction, a radial direction, and a circumferential direction of the rotor core 11 will simply be referred to as the axial direction, the radial direction, and the circumferential direction, respectively.

The rotor core 11 includes a laminated body formed by rotationally stacking multiple rotor iron core pieces 13. Each rotor iron core piece 13 is made of a magnetic steel sheet.

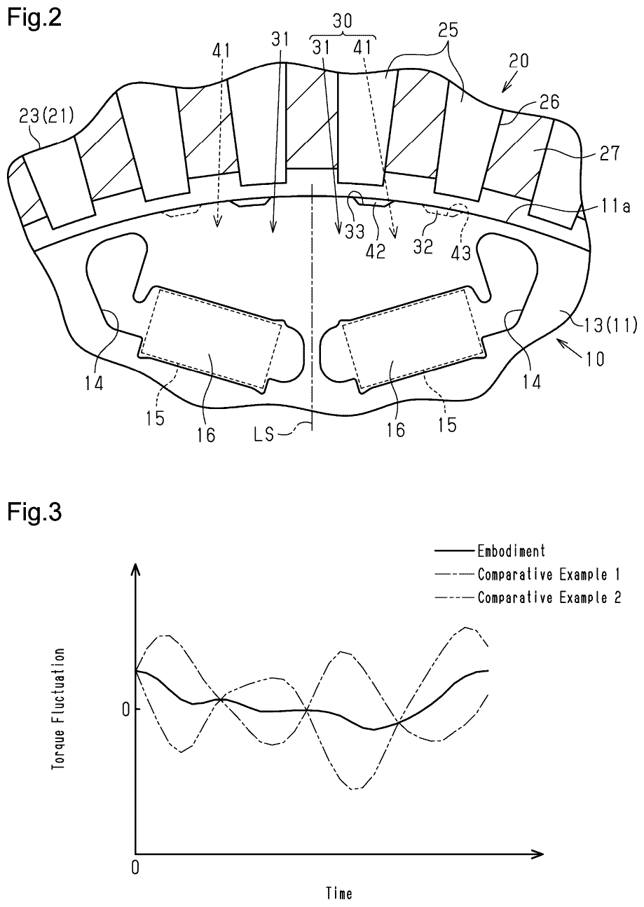

The magnet housing holes 14 are spaced apart from each other in the circumferential direction. The magnet housing holes 14 are inclined with respect to the circumferential direction. Specifically, the magnet housing holes 14 include eight pairs of magnet housing holes 14 provided at intervals in the circumferential direction. As shown in FIG. 2, the magnet housing holes 14 in each pair are provided so as to be consecutive in the circumferential direction and symmetrical with respect to an imaginary straight line LS extending in the radial direction. Accordingly, the inclination directions of the magnet housing holes 14 in each pair with respect to the circumferential direction are opposite to each other. In the present embodiment, the magnet housing holes 14 in each pair are each inclined so as to be shifted radially inward as it extends toward the imaginary straight line LS in the circumferential direction.

The center hole 12 and the magnet housing holes 14 extend through the rotor core 11 in the axial direction.

Each magnet 15 has a rectangular parallelepiped shape extending along an axis C.

### Designated Regions 30

Each rotor iron core piece 13 includes multiple designated regions 30.

As shown in FIG. 1, the designated regions 30 of each rotor iron core piece 13 are each formed by a part of the rotor iron core piece 13 between one of the magnet housing holes 14 and the outer circumferential surface 11a of the rotor iron core piece 13 located on the radially outer side of the magnet housing hole 14. The designated regions 30 of each rotor iron core piece 13 thus correspond to the magnet housing holes 14 of the rotor iron core piece 13.

The designated regions 30 include multiple first designated regions 31 and multiple second designated regions 41.

In the present embodiment, the first designated regions 31 correspond to eight of the magnet housing holes 14 that are consecutive in the circumferential direction. The first designated regions 31 in each pair are provided to correspond to the magnet housing holes 14 of the corresponding pair. The first designated regions 31 in each pair are also consecutive in the circumferential direction and symmetrical with respect to the imaginary straight line LS.

Therefore, hereinafter, one of the two first designated regions 31 in each pair will be described, and the description of the other first designated region 31 will be omitted.

As shown in FIG. 2, each first designated region 31 includes a flat plate-shaped first general portion 32 and a first cutout 33, which is formed in the outer circumferential surface 11a of the rotor iron core piece 13 and has a substantially trapezoidal shape in plan view.

The first cutouts 33 extend through the rotor iron core piece 13 in the thickness direction.

The two first cutouts 33 in the first designated regions 31 in each pair are symmetrical with respect to the imaginary straight line LS.

The second designated regions 41 are provided in some of the designated regions 30 that are different from the first designated regions 31. In the present embodiment, the second designated regions 41 correspond to the remaining eight magnet housing holes 14, which are consecutive in the circumferential direction and do not correspond to the first designated regions 31. The second designated regions 41 in each pair are provided to correspond to the magnet housing holes 14 of the corresponding pair. The second designated regions 41 in each pair are also consecutive in the circumferential direction and symmetrical with respect to the imaginary straight line LS.

Therefore, hereinafter, one of the two second designated regions 41 in each pair will be described, and the description of the other second designated region 41 will be omitted.

Each second designated region 41 includes a flat plate-shaped second general portion 42 and a second cutout 43, which is formed in the outer circumferential surface 11a of the rotor iron core piece 13 and has a substantially trapezoidal shape in plan view.

The second cutouts 43 extend through the rotor iron core piece 13 in the thickness direction.

The two second cutouts 43 in the second designated regions 41 in each pair are symmetrical with respect to the imaginary straight line LS.

The position of the first cutout 33 in each first designated region 31 is different from the position of the second cutout 43 in each second designated region 41. In the present embodiment, the second cutouts 43 in each pair are provided at positions farther away in the circumferential direction from the imaginary straight line LS than the first cutouts 33 in each pair are.

The rotor iron core pieces 13 are rotationally stacked such that the first designated regions 31 and the second designated regions 41 alternately overlap in the axial direction. In any two of the rotor iron core pieces 13 that are adjacent to each other in the axial direction, each first general portion 32 of one of the rotor iron core pieces 13 overlaps with one of the second cutouts 43 of the other rotor iron core piece 13 in the axial direction. Also, in any two of the rotor iron core pieces 13 that are adjacent to each other in the axial direction, each first cutout 33 of one of the rotor iron core pieces 13 overlaps with one of the second general portions 42 of the other rotor iron core piece 13 in the axial direction.

Stator 20 As shown in FIG. 1, the stator 20 includes a stator core 21 and coils 27.

The stator core 21 has a substantially cylindrical shape having a center hole 22. The stator core 21 and the rotor core 11 are located on the same axis C.

Hereinafter, the axial direction, the radial direction, and the circumferential direction of the stator core 21 respectively agree with the axial direction, the radial direction, and the circumferential direction of the rotor core 11.

The stator core 21 includes a laminated body formed by rotationally stacking multiple stator iron core pieces 23. Each stator iron core piece 23 is made of a magnetic steel sheet.

The stator core 21 includes an annular yoke 24 and multiple teeth 25 that extend radially inward from the yoke 24 and are formed at intervals in the circumferential direction.

A slot 26 is formed between adjacent ones of the teeth 25 in the circumferential direction. The slot 26 opens inward in the radial direction and extends in the radial direction. The slots 26 extend through the stator core 21 in the axial direction and are connected to the center hole 22 in the radial direction.

The coils 27, which are wound around the outer periphery of the teeth 25, are inserted into the slots 26.

The rotor core 11 is rotatably provided inside the stator 20.

In the present embodiment, the first cutouts 33 correspond to the different-shape portions according to the present disclosure, and the first designated regions 31 correspond to the first designated regions having the different-shape portions. Further, in the present embodiment, the second designated regions 41 correspond to the designated regions that do not include the different-shape portions.

Operation of the present embodiment will now be described.

As shown in FIG. 3, the torque fluctuations due to the magnetic interaction between the stator 20 and the rotor 10 in the designated regions 30 vary depending on the presence or absence of the first cutouts 33 and the second cutouts 43.

In FIG. 3, temporal changes in the torque fluctuation of the rotor 10 in the present embodiment are indicated by the solid line. The torque fluctuation of a rotor of Comparative Example 1 is indicated by the long-dash short-dash line, and the torque fluctuation of a rotor of Comparative Example 2 is indicated by the long-dash double-short-dash line. The rotor of Comparative Example 1 is different from the rotor 10 of the present embodiment in that all the designated regions 30 of the rotor iron core pieces 13 are formed by the first designated regions 31, which have the first cutouts 33. The rotor of Comparative Example 2 is different from the rotor 10 of the present embodiment in that all the designated regions 30 of the rotor iron core pieces 13 are formed by the second designated regions 41, which have the second cutouts 43.

Torque fluctuations different from each other occur in the first designated regions 31 and the second designated regions 41, respectively.

According to the above-described configuration of the present embodiment, the first designated regions 31 and the second designated regions 41 of the rotor iron core pieces 13 overlap in the axial direction of the rotor 10. Therefore, by rotationally stacking multiple rotor iron core pieces 13 having the same shape, the rotor iron core pieces 13 having mutually different torque fluctuation characteristics are stacked. As a result, torque fluctuations of the rotor iron core pieces 13 can be cancelled out by the stacked rotor iron core pieces 13.

The present embodiment has the following advantages.

(1) The first designated regions 31 are each provided with the first cutout 33 located in a different position from the second cutout 43 in each second designated region 41. Each first designated region 31 overlaps with one of the second designated regions 41 in the axial direction.

This configuration operates in the above-described manner and thus facilitates the manufacture of the rotor 10 as compared to a case in which multiple types of rotor iron core pieces having different shapes are stacked.

(2) The first cutouts 33 and the second cutouts 43 extend through each rotor iron core piece 13 in the thickness direction. The first designated regions 31 each have a flat plate-shaped first general portion 32 in a part overlapping with the corresponding second cutout 43 in the axial direction. The second designated regions 41 each have a flat plate-shaped second general portion 42 in a part overlapping with the corresponding first cutout 33 in the axial direction.

For example, in a configuration in which different-shape portions protrude in relation to flat plate-shaped general portions of each rotor iron core piece, the different-shape portions interfere with another rotor iron core piece adjacent to the rotor iron core piece having the different-shape portions.

In this regard, according to the above-described configuration, when the multiple rotor iron core pieces 13 are stacked, the plate-shaped second general portions 42 overlap with the first cutouts 33, which extend through the rotor iron core pieces 13, in the thickness direction. Therefore, the first cutouts 33 do not interfere with another rotor iron core piece 13 adjacent to the rotor iron core piece 13 having the first cutouts 33.

When the multiple rotor iron core pieces 13 are stacked, the plate-shaped first general portions 32 overlap with the second cutouts 43, which extend through the rotor iron core pieces 13, in the thickness direction. Therefore, the second cutouts 43 do not interfere with another rotor iron core piece 13 adjacent to the rotor iron core piece 13 having the second cutouts 43.

(3) The first cutouts 33 and the second cutouts 43 are formed in the outer circumferential surface 11a of each rotor iron core piece 13.

With this configuration, the clearance between each of the cutouts in the outer circumferential surface 11a of each rotor iron core piece 13 and the stator 20 facing the cutout, is larger than in the other parts. The clearance is also referred to as an “air gap”. The above-described clearance causes the magnetic flux distribution in the vicinity of each cutout to be more likely to change than in the other parts. As a result, the torque fluctuation greatly differs between the first designated region 31 and the second designated region 41. Therefore, it is possible to cancel the torque fluctuation of the rotor iron core pieces 13 with a simple configuration.

(4) The two magnet housing holes 14 in each pair, which are consecutive in the circumferential direction, are symmetrical with respect to the imaginary straight line LS. The two first cutouts 33 in each pair are symmetrical with respect the imaginary straight line LS, and the two second cutouts 43 in each pair are symmetrical with respect the imaginary straight line LS.

This configuration prevents a difference in torque fluctuation characteristics from being caused by the first cutouts 33 and the second cutouts 43 between the forward rotation and the reverse rotation of the rotor 10.

### Modifications

The above-described embodiment may be modified as follows. The above-described embodiment and the following modifications can be combined as long as the combined modifications remain technically consistent with each other.

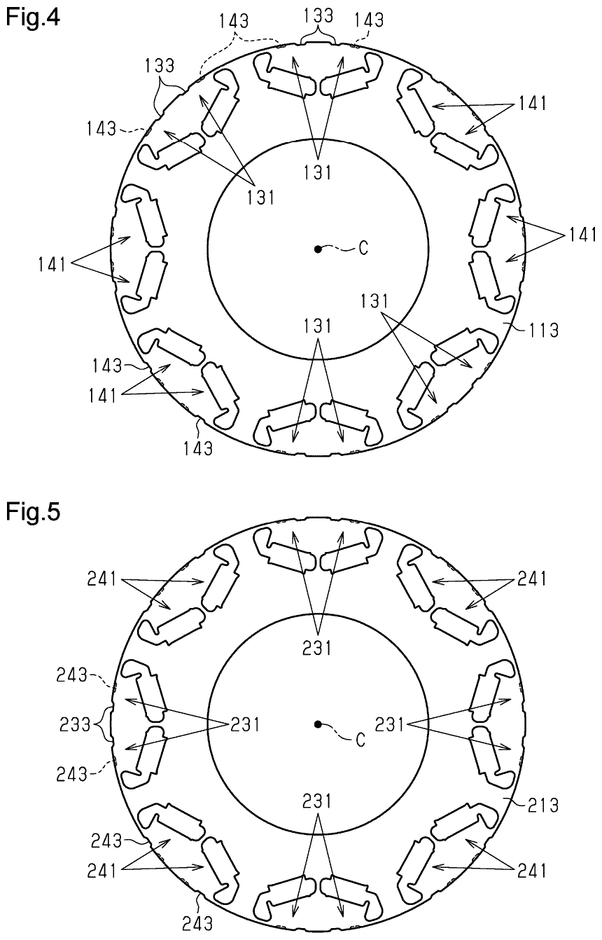

In the above-described embodiment, the first cutouts 33 are provided in the eight first designated regions 31, which are consecutive in the circumferential direction, and the second cutouts 43 are provided in the eight second designated regions 41, which are consecutive in the circumferential direction. However, the present disclosure is not limited to this. For example, as shown in FIG. 4, first cutouts 133 may be provided in four first designated regions 131, consecutive in the circumferential direction, and second cutouts 143 may be provided in four second designated regions 141, consecutive in the circumferential direction. Sets of four first designated regions 131 and sets of four second designated regions 141 are alternately arranged in the circumferential direction. Even in this case, each set of four first designated regions 131 and the corresponding set of four second designated regions 141 may be stacked in the axial direction by rotationally stacking the rotor iron core pieces 113. Also, as shown in FIG. 5, first cutouts 233 may be provided in two first designated regions 231, consecutive in the circumferential direction, and second cutouts 243 may be provided in two second designated regions 241, consecutive in the circumferential direction. Sets of two first designated regions 231 and sets of two second designated regions 241 are alternately arranged in the circumferential direction. Even in this case, each set of two first designated regions 231 and the corresponding set of two second designated regions 241 may be stacked in the axial direction by rotationally stacking the rotor iron core pieces 213.

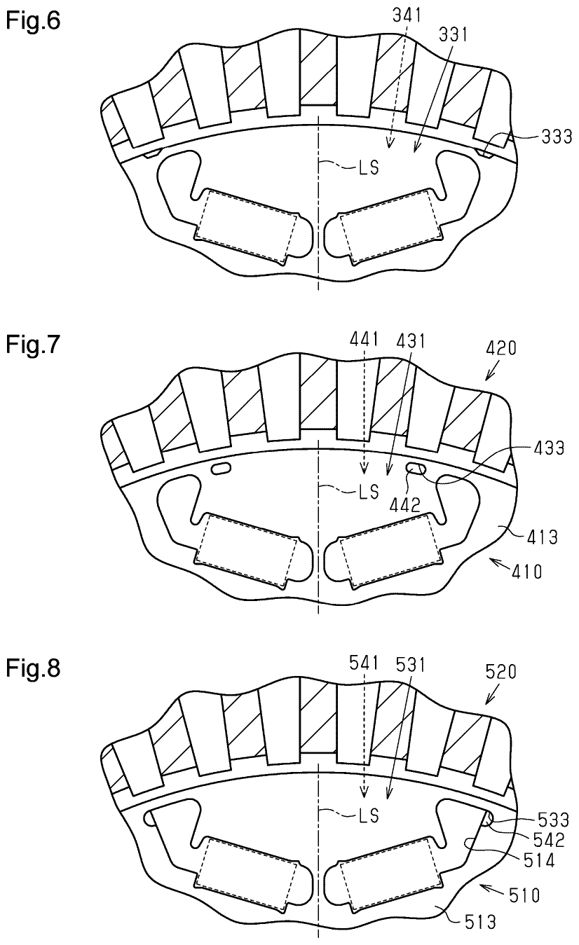

As shown in FIG. 6, the second cutout may be omitted from each second designated region 341. Even in this case, the shape or the positions of cutouts 333 in each first designated region 331 can be changed so as to cancel out the torque fluctuation characteristics of second designated regions 341.

In the above-described embodiment, the two magnet housing holes 14 in each pair, which are consecutive in the circumferential direction, are symmetrical with respect to the imaginary straight line LS. However, the present disclosure is not limited to this. For example, an imaginary straight line may be provided such that two sets of magnet housing holes 14 that are consecutive in the circumferential direction are symmetrical with respect to an imaginary straight line. Even in this case, the first cutouts 33 of two sets of the magnet housing holes 14 may be symmetrical with respect to the imaginary straight line.

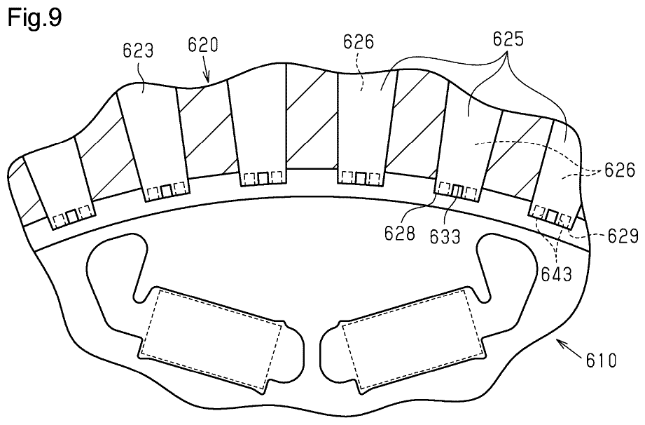

In the above-described embodiment, the different-shape portions are formed by the first cutouts 33. However, the present disclosure is not limited to this. For example, as shown in FIG. 7, each different-shape portion may be a through-hole 433 formed in a first designated region 431 of a rotor iron core piece 413. Further, as shown in FIG. 8, each different-shape portion may be a through-hole 533 connected to a magnet housing hole 514 of a first designated region 531 of a rotor iron core piece 513. In FIGS. 7 and 8, second designated regions 441, 541 are formed solely by plate-shaped second general portions 442, 542. When the cutouts 33, 43 are formed in each rotor iron core piece 13, the clearance between the outer circumferential surface 11a of the rotor 10 and the stator 20 is increased by the size of the cutouts. Therefore, the magnetic flux acting between the stator 20 and the rotor 10 is reduced, so that the torque acting on the rotor 10 may be reduced. In this regard, according to the configurations shown in FIGS. 7 and 8, since the different-shape portions are the through-holes 433, 533 formed in the rotor iron core pieces 413, 513, the clearances between the outer circumferential surface of the rotor 410, 510 and the stator 420, 520 are not increased by the different-shape portions. As a result, it is possible to cancel out torque fluctuations while suppressing a decrease in the torque of the motor due to formation of the different-shape portions.

In the above-described embodiment, each second general portion 42 is provided in a part of a designated region 30 that overlaps with the corresponding first cutout 33 in the axial direction, and each first general portion 32 is provided in a part of a designated region 30 that overlaps with the corresponding second cutout 43 in the axial direction. However, the present disclosure is not limited to this. For example, a protrusion may be provided in a part of each designated region 30 that overlaps with the corresponding first cutout 33 in the axial direction. Also, a protrusion may be provided in a part of each designated region 30 that overlaps with the corresponding second cutout 43 in the axial direction.

In the above-described embodiment, eight first designated regions 31 are provided. However, at least one first designated region 31 may be provided.

In the above-described embodiment, torque fluctuation characteristics different from each other are generated in the first designated regions 31 and the second designated regions 41 by differentiating the positions of the first cutouts 33 and the second cutouts 43. However, but the present invention is not limited thereto. For example, different torque fluctuation characteristics may be generated in the first designated regions 31 and the second designated regions 41 by making the shapes of the first cutouts 33 and the second cutouts 43 different from each other.

In the above-described embodiment, the rotor core 11 is formed by rotationally stacking the rotor iron core pieces 13. However, the rotor core 11 may be formed by rotationally stacking multiple blocks that are each formed by stacking some of the rotor iron core pieces 13. In this case, the different-shape portion may be formed in at least one of multiple designated regions of each block.

In the above-described embodiment, the rotor 10 is provided with the different-shape portions. However, the stator may be provided with different-shape portions. For example, as shown in FIG. 9, one first cutout 633 is provided in a distal end face 628 of each of multiple teeth 625. In addition, two second cutouts 643 are provided in a distal end face 629 of another tooth 626. Each tooth of the multiple teeth 625 and the corresponding other tooth 626 overlap in the axial direction. In this case, the torque fluctuations due to the magnetic interaction between a stator 620 and a rotor 610 in the teeth 625 vary depending on the presence or absence of the first cutouts 633. For this reason, different torque fluctuations occur between the tooth 626 having the first cutout 633 and the other tooth 625 not having the first cutout 633. With this configuration, the teeth 625 and the other teeth 626 overlap in the axial direction. Therefore, by rotationally stacking multiple stator iron core pieces 623 having the same shape, the stator iron core pieces 623 having mutually different torque fluctuation characteristics are stacked. As a result, torque fluctuations of the stator iron core pieces 623 can be cancelled out by the stacked stator iron core pieces 623. This facilitates the manufacture of the stator 620 as compared to a case in which multiple types of iron core pieces having different shapes are stacked.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A rotor that is employed in a magnet-embedded motor of an inner rotor type, the rotor comprising a rotor core formed by rotationally stacking multiple iron core pieces or by rotationally stacking multiple blocks each formed by stacking multiple iron core pieces, wherein
the rotor core includes multiple magnet housing holes provided at intervals in a circumferential direction of the rotor,
a magnet is accommodated in each of the magnet housing holes,
a part of the rotor core between each magnet housing hole and an outer circumferential surface of the rotor core located on a radially outer side of the magnet housing hole is defined as a designated region,
the designated regions include at least one first designated region including a different-shape portion different in shape or position from those in the other designated regions, and
in the multiple iron core pieces or in the multiple blocks, the first designated region and one of the designated regions that does not include the different-shape portion overlap in an axial direction of the rotor.

2. The rotor according to claim 1, wherein
the different-shape portion extends in a thickness direction through the iron core piece or the block having the different-shape portion, and
the designated region of the iron core piece or the block that does not include the different-shape portion includes a flat plate-shaped general portion in a part overlapping with the different-shape portion in the axial direction.

3. The rotor according to claim 2, wherein the different-shape portion is a cutout formed in an outer circumferential surface of the iron core piece or the block including the different-shape portion.

4. The rotor according to claim 2, wherein the different-shape portion is a through-hole formed in the iron core piece or the block including the different-shape portion.

5. The rotor according to claim 1, wherein
the magnet housing holes include two magnet housing holes consecutive in the circumferential direction of the rotor, the two magnet housing holes being symmetrical with respect to an imaginary straight line extending in a radial direction of the rotor,
the at least one first designated region includes two first designated regions that respectively correspond to the two magnet housing holes, and
the two different-shape portions in the two first designated regions are symmetrical with respect to the imaginary straight line.

6. A stator that is employed in a magnet-embedded motor of an inner rotor type, the stator comprising a stator core formed by rotationally stacking multiple iron core pieces or by rotationally stacking multiple blocks each formed by stacking multiple iron core pieces, wherein
the stator core includes an annular yoke and multiple teeth protruding from the yoke in a radial direction of the yoke,
coils are wound around the teeth,
at least one of the teeth includes a different-shape portion different in shape or position from those in the other teeth, and
in the multiple iron core pieces or in the multiple blocks, the tooth including the different-shape portion and one of the teeth that does not include the different-shape portion overlap in an axial direction of the stator.
